(19) United States
(12) Patent Application Publication
(10) Pub. No.: US 2021/0023449 A1
(43) Pub. Date: Jan. 28, 2021

(54) GAME SCENE DESCRIPTION METHOD AND APPARATUS, DEVICE, AND STORAGE MEDIUM

(71) Applicant: GUANGZHOU HUYA INFORMATION TECHNOLOGY CO., LTD., Guangzhou, Guangdong (CN)

(72) Inventors: Xiaodong Wu, Guangzhou (CN); Lu LIU, Guangzhou (CN)

(21) Appl. No.: 16/977,831

(22) PCT Filed: May 24, 2019
(86) PCT No.: PCT/CN2019/088348

§ 371 Date: Sep. 3, 2020

(30) Foreign Application Priority Data
May 25, 2018 (CN) 201810517799.X

(51) Int. Cl. A63F 13/52; A63F 13/86; A63F 13/5378

(52) U.S. Cl. CPC A63F 13/52; A63F 13/5378; A63F 13/86

(57) ABSTRACT

A game scene description method and apparatus, a device, and a storage medium is provided. The method includes: obtaining at least one video frame from a game live video stream; capturing a game map region image in the at least one video frame; inputting the game map region image into a first target detection model to obtain a display region of a game element on the game map region image; inputting an image of the display region of the game element into a classification model to obtain a state of the game element; and forming description information of a game scene displayed by the at least one video frame by the display region and the state of the game element.

### CROSS-REFERENCES TO RELATED APPLICATIONS

This application claims priority to PCT Application No. PCT/CN2019/088348, filed on May 24, 2019 which is based upon and claims priority to Chinese Patent Application No. 201810517799.X, filed on May 25, 2018, the entire contents both of which are incorporated herein by reference.

### FIELD OF TECHNOLOGY

Embodiments of the present application relate to the field of computer vision technology, for example, to a game scene description method and apparatus, a device, and a storage medium.

### BACKGROUND

With the development of the game live broadcast industry and the increasing number of game anchors, an anchor client sends a large volume of game live broadcast video stream to a server, and the server issues the game live broadcast video stream to a user client for watching.

Information carried by the game live broadcast video stream is strictly limited, such as a live broadcast room number, an anchor name, an anchor signature corresponding to the game live broadcast video stream.

### SUMMARY

An aspect relates to a game scene description method and apparatus, a device, and a storage medium, to accurately describe a game scene inside a game live broadcast video stream. In a first aspect, an embodiment of the present application provides a game scene description method. The game scene description method includes: at least one video frame in a game live broadcast video stream is acquired; a game map area image in the at least one video frame is captured; the game map area image is input to a first target detection model to obtain a display area of a game element in the game map area image; an image of the display area of the game element is input to a classification model to obtain a state of the game element; and description information of a game scene displayed by the at least one video frame is formed by adopting the display area and the state of the game element.

In a second aspect, an embodiment of the present application further provides a game scene description apparatus. The game scene description apparatus includes an acquisition module, a capturing module, a display area recognition module, a state recognition module, and a forming module. The acquisition module is configured to acquire at least one video frame in a game live broadcast video stream. The capturing module is configured to capture a game map area image in the at least one video frame. The display area recognition module is configured to input the game map area image to a first target detection model to obtain a display area of a game element in the game map area image. The state recognition module is configured to input an image of the display area of the game element to a classification model to obtain a state of the game element. The forming module is configured to form description information of a game scene displayed by the at least one video frame by adopting the display area and the state of the game element.

In a third aspect, an embodiment of the present application further provides an electronic device. The electronic device includes one or more processors and a memory configured to store one or more programs. The one or more programs, when executed by the one or more processors, cause the one or more processors to implement the game scene description method of any one of the embodiments.

In a fourth aspect, an embodiment of the present application further provides a computer-readable storage medium. A computer program is stored on the computer-readable storage medium. The program, when executed by a processor, implements the game scene description method of any one of the embodiments.

### BRIEF DESCRIPTION

Some of the embodiments will be described in detail, with reference to the following figures, wherein like designations denote like members, wherein:

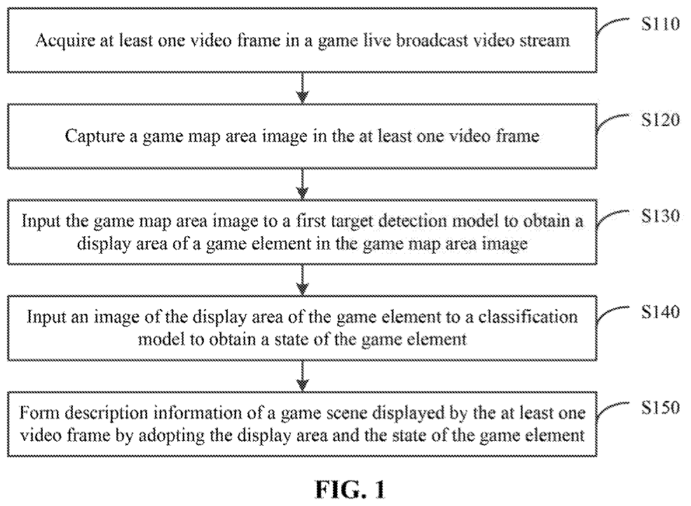

FIG. 1 is a flowchart of a game scene description method provided in an embodiment one of the present application;

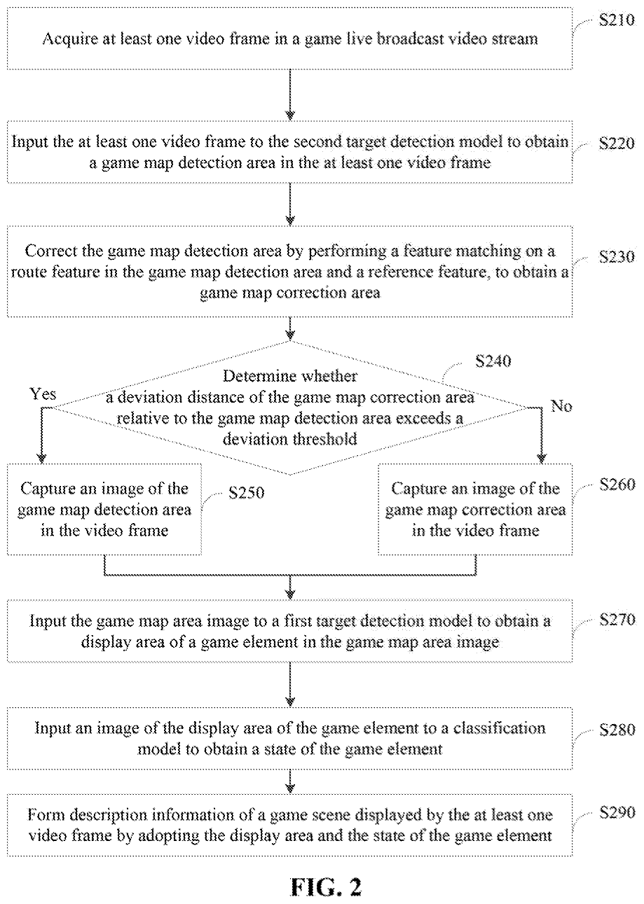

FIG. 2 is a flowchart of a game scene description method provided in an embodiment two of the present application;

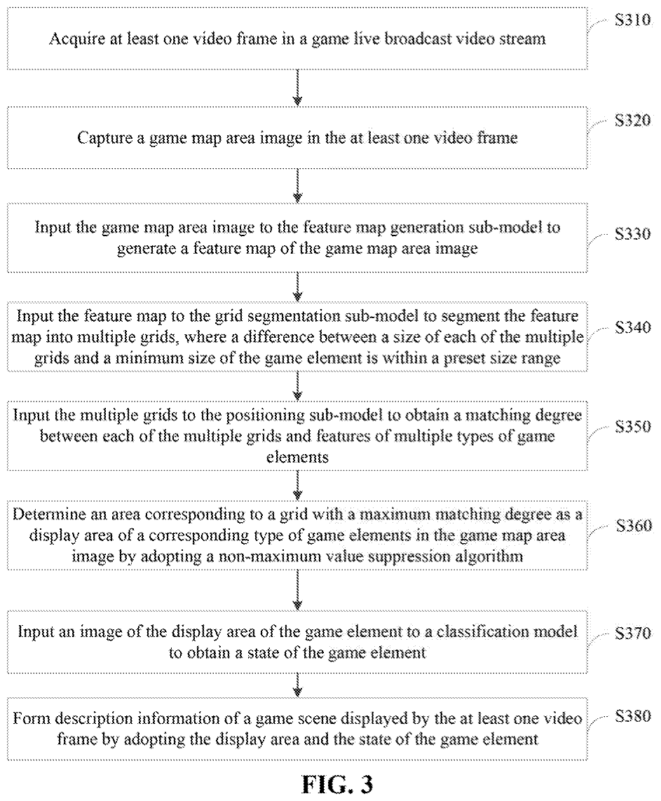

FIG. 3 is a flowchart of a game scene description method provided in an embodiment three of the present application;

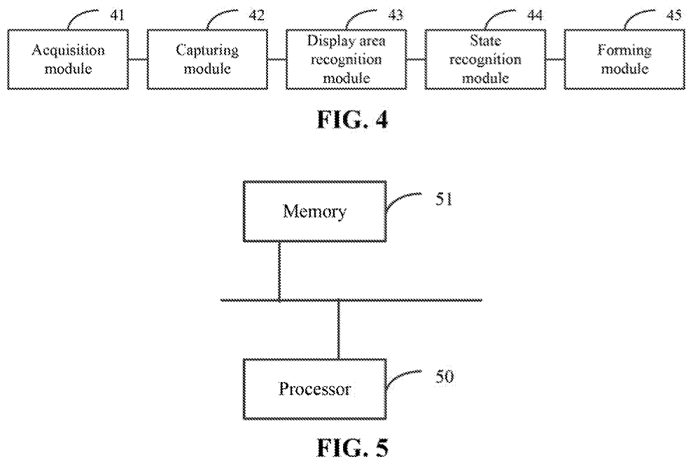

FIG. 4 is a structural diagram of a game scene description apparatus provided in an embodiment four of the present application; and

FIG. 5 is a structural diagram of an electronic device provided in an embodiment five of the present application.

### DETAILED DESCRIPTION

The present application will be described in conjunction with the drawings and embodiments below. It should be understood that the specific embodiments described herein are merely used for explaining the present application and are not intended to limit the present application. It should also be noted that, for ease of description, only some, but not all, of the structures related to the present disclosure are shown in the drawings.

### Embodiment One

FIG. 1 is a flowchart of a game scene description method provided in an embodiment one of the present application. This embodiment may be applied to a case of describing a game scene inside a game live broadcast video stream. The method may be executed by a game scene description apparatus. This apparatus may be composed of hardware and/or software, and may generally be integrated in a server, an anchor client, or a user client. The method includes following steps.

In S110, at least one video frame in a game live broadcast video stream is acquired.

The game scene description apparatus receives a game live broadcast video stream corresponding to an anchor live broadcast room in real time. The game live broadcast video stream refers to a video stream containing video content of a game, for example, a video stream of King of Glory, and a video stream of League of Legends. In order to ensure the real-time performance of the video frame, and further to ensure the accuracy and timeliness of a subsequently recognized content, at least one video frame is captured from any position in the currently received game live broadcast video stream.

In S120, a game map area image in the at least one video frame is captured.

A game display interface is displayed in the video frame. This game display interface is a main interface of a game application, and a game map is displayed on the game display interface. For ease of description and differentiation, an image of a display area of the game map is referred to as the game map area image.

In an embodiment, the step in which the game map area image in the at least one video frame is captured includes at least following two implementation manners.

In a first implementation manner, in order to facilitate game playing of players, the game map is generally displayed in a preset display area of the game display interface. The display area of the game map may be represented in a form of (abscissa value, ordinate value, width, height), and the display area of the game map will vary depending on game types. Based on this, the display area of the game map is determined according to the game types; and the image of the display area of the game map in the at least one video frame is captured. It is worth noting that, in the first implementation manner, the display area of the game map on the game display interface serves as the display area of the game map on the video frame. When the video frame displays the game display interface in a full-screen manner, a more accurate result may be obtained in this first implementation manner.

In a second implementation manner, the display area of the game map is recognized based on a target detection model. The target detection model includes, but is not limited to, a convolutional network such as a You Only Look Once (Yolo), a Residual Neural Network (ResNet), a MobileNetV1, a MobileNetV2, and a Single Shot Multibox Detector (SSD), or includes a Faster Regions with Convolutional Neural Network (FasterRCNN), etc. The target detection model extracts a feature of the video frame, the feature of the video frame is matched with a feature of a pre-stored game map to obtain the display area of the game map; and the image of the display area of the game map in the at least one video frame is captured. It is worth noting that, when the video frame displays the game display interface in a full-screen manner or in a non-full-screen manner, a more accurate result may be obtained in this second implementation manner.

In S130, the game map area image is input to a first target detection model to obtain a display area of a game element in the game map area image.

In S140, an image of the display area of the game element is input to a classification model to obtain a state of the game element.

The game elements in the game map include, but are not limited to, a game character, a defensive tower, and a beast, etc. The states of the game elements include, but are not limited to, a name of the game character, a survival state of the game character, a team to which the game character belongs, and a type of the game character. For example, the states of the game elements includes: the name of the game character, the team to which the game character belongs, the survival state of the game character, a name of the defensive tower, a survival state of the defensive tower, a team to which the defensive tower belongs, a name of the beast, and a survival state of the beast are all included. The display areas and the states of the game elements may reflect a current game situation.

For ease of description and differentiation, a model for detecting the display area of the game element is referred to as the first target detection model, and the model for detecting the display area of the game map described above is referred to as a second target detection model. In an embodiment, the second target detection model includes, but is not limited to, a convolutional network such as a Yolo, a ResNet, a MobileNetV1, a MobileNetV2, and a SSD, or includes a FasterRCNN, etc. The classification model includes, but is not limited to, a Cifar10 lightweight classification network, a ResNet, a MobileNet, an Inception, etc.

In S150, description information of a game scene displayed by the at least one video frame is formed by adopting the display area and the state of the game element.

The display area of the game element output by the first target detection model is in a digital format, for example, the display area of the game element is represented in a form of (abscissa value, ordinate value, width, height). In another example, the display area of the game element is directly represented in a form of (abscissa value, ordinate value) if the width and the height of the game element are preset.

The state output by the classification model is in a character format, such as a name of the game character, and a number of the game character, a type of the defensive tower, a survival state of the defensive tower. In an embodiment, the format of the description information may be a chart, a text, a number, or a character; and contents of the description information include, but are not limited to, an attack route, a manner, a degree of participation.

The S150 includes following several implementation manners according to different numbers of video frames and different formats of the description information.

In an implementation manner, the number of video frames may be one, two or more. The display area in the digital format and the state in the character format of the game element in at least one video frame are combined into an array, e.g., (abscissa, ordinate, state), which is directly used as the description information of the game scene.

In another implementation manner, the number of video frames may be one, two or more. The display area in the digital format and the state in the character format described above are converted into texts, and a conjunction is added between the texts to form the description information of the game scene. For example, the description information indicates that in the first video frame, a survival state of a defensive tower in the base of the anchor's faction is full health, and game characters of the anchor's faction gather in the middle lane; in the second video frame, the survival state of the defensive tower in the base of the anchor's faction is low health, and the game characters of the anchor party gathers in the base.

In still another implementation manner, the number of video frames is one. A correspondence between the description information and the display area and the state of the game element is pre-stored; and description information of a game scene displayed by a video frame is obtained according to the correspondence between the description information and a display area and a state of a game element in the video frame. For example, a situation where the survival state of the defensive tower in the base of the anchor's faction is full health and the game characters of the anchor's faction gather in the middle lane corresponds to “the anchor's faction is expected to win”. In another example, a situation where the survival state of the defensive tower in the base of the anchor's faction is low health and the game characters of the anchor's faction gather in the base corresponds to “the anchor's faction is defends”.

In still another implementation manner, the number of video frames is two or more. A change trend of the display area of the game element is obtained from the display area of the game element in the two or more video frames, and a change trend of the state of the game element is obtained from the state of the game element in the two or more video frames, and these change trends may be represented in the form of a chart; description information of a game scene displayed by the two or more video frames is obtained according to a correspondence between the change trends and the description information. For example, a change trend of “a defensive tower in the base of the anchor's faction is losing health” corresponds to “the anchor's faction is going to fail”. For another example, a change trend of “the game character of the anchor moves from the middle of the map to the enemy's base” corresponds to “the anchor's faction is attacking the crystal”.

In this embodiment, a game map, which is capable of reflecting a game situation, is acquired from the game live broadcast video stream by acquiring the at least one video frame in the game live broadcast video stream and capturing the game map area image in the at least one video frame; the display area and the state of the game element in the game map area image are obtained through the first target detection model and the classification model, the display area and the state of the game element are extracted by applying an image recognition algorithm based on a deep learning for the understanding of the game map; and then, the description information of the game scene displayed by the at least one video frame is formed by adopting the display area and the state of the game element, so that a specific game scene inside the game live broadcast video stream is obtained by taking the game map as a recognization object and in conjunction with the image recognization algorithm, which facilitates the subsequent push or classification of the game live broadcast video stream of the specific game scene, satisfies the personalized requirements of users, and is conductive to improve the content distribution efficiency of the game live broadcast industry.

### Embodiment Two

This embodiment describes the S120 in the above embodiment. In this embodiment, the step in which the game map area image in the at least one video frame is captured includes: the at least one video frame is input to the second target detection model to obtain a game map detection area in the at least one video frame; the game map detection area is corrected by performing a feature matching on a route feature in the game map detection area and a reference feature, to obtain a game map correction area; and in a case where a deviation distance of the game map correction area relative to the game map detection area exceeds a deviation threshold, an image of the game map detection area in the video frame is captured; and in a case where the deviation distance of the game map correction area relative to the game map detection area does not exceed the deviation threshold, an image of the game map correction area in the video frame is captured. FIG. 2 is a flowchart of a game scene description method provided in an embodiment two of the present application. As shown in FIG. 2, the method provided in this embodiment includes steps described below.

In S210, at least one video frame in a game live broadcast video stream is acquired.

The S210 is the same as the S110, which will not to be detailed here again.

In S220, the at least one video frame is input to the second target detection model to obtain a game map detection area in the at least one video frame.

Before the at least one video frame is input to the second target detection model, the method further includes to train the second target detection model. In an embodiment, a training process of the second target detection model includes following two steps. In other words, the second target detection model may be generated by training in a method including following two steps.

In a first step, multiple sample video frames are acquired. The multiple sample video frames and the at least one video frame in the S210 correspond to a same game type, and image features such as a color, a texture, a path and a size of the game map of the same game type are the same. The second target detection model trained through the sample video frames may be applied to the recognition of the display area of the game map.

In a second step, the second target detection model is trained by using a training sample set constituted of the multiple sample video frames and the display area of the game map in the multiple sample video frames. In an embodiment, a difference between a display area output by the second target detection model and the display area in the sample set is used as a cost function, and iteration is repeated on parameters of the second target detection model until the cost function is lower than a loss threshold, and the training of the second target detection model is completed.

The second target detection model includes a feature map generation sub-model, a grid segmentation sub-model and a positioning sub-model which are connected in sequence. In the S220, the at least one video frame is input to the feature map generation sub-model to generate a feature map of the video frame. The feature map may be two-dimensional or three-dimensional. Then, the feature map of the video frame is input to the grid segmentation sub-model to segment the feature map into multiple grids; a difference between a size of the grid and the size of the game map is within a preset size range. In specific implementation, the size of the grid is expressed by adopting a hyper-parameter, and is set according to the size of the game map before the second target detection model is trained. Next, multiple grids are input to the positioning sub-model which loads features of a standard game map. The positioning sub-model matches each of the grids with the features of the standard game map to obtain a matching degree of each grid and each and every feature of the standard game map. The matching degree is a cosine or a distance of these two features, for example. An area corresponding to a grid with the matching degree exceeding a matching degree threshold serves as the game map detection area. If no grid with the matching degree exceeding the matching degree threshold exists, the game map does not exist in the video frame, and then the positioning sub-model directly outputs “no game map”.

It can be seen that the game map detection area is directly recognized by the second target detection model. In some embodiments, an image of the game map detection area may be captured directly from the video frame as the game map area image.

In S230, the game map detection area is corrected by performing a feature matching on a route feature in the game map detection area and a reference feature, to obtain a game map correction area.

Considering that errors may exist in the game map detection area, in this embodiment, the game map detection area is corrected. Exemplarily, reference features of routes in a standard game map area are pre-stored, such as a route angle, a route width, a route color. A straight line with specified width and angle in the game map detection area is extracted as the route feature. Feature matching is performed on the route feature in the game map detection area and the reference feature, that is, the matching degree of the route feature described above and the reference feature is calculated. If the matching degree is greater than the matching degree threshold, an image of the game map detection area is captured from the video frame as the game map area image. If the matching degree is less than or equal to the matching degree threshold, the display position of the game map detection area is corrected until the matching degree is greater than the matching degree threshold. The corrected area is referred to as the game map correction area. In some embodiments, the image of the game map correction area is captured from the video frame as the game map area image.

In S240, whether a deviation distance of the game map correction area relative to the game map detection area exceeds a deviation threshold is determined; and the process jumps to S250 in response to a determination result that the deviation distance of the game map correction area relative to the game map detection area exceeds the deviation threshold, and the process jumps to S260 in response to a determination result that the deviation distance of the game map correction area relative to the game map detection area does not exceed the deviation threshold.

In S250, an image of the game map detection area in the video frame is captured. The process jumps to step S270.

In S260, an image of the game map correction area in the video frame is captured. The process jumps to step S270.

Considering that the game map correction area may be excessively corrected to result in inaccurate positioning of the game map, in this embodiment, the deviation distance of the game map correction area relative to the game map detection area is calculated, for example, a deviation distance of a center of the game map correction area relative to a center of the game map detection area is calculated, or a deviation distance of an upper right corner of the game map correction area relative to an upper right corner of the game map detection area is calculated. If a deviation distance of the game map correction area of one video frame of the at least one video frame relative to the game map detection area of this video frame exceeds the deviation threshold, it means that the game map correction area of this video frame is corrected excessively, then the game map correction area of this video frame is discarded, and the image of the game map detection area of this video frame is captured as the game map area image of this video frame; if the deviation distance does not exceed the deviation threshold, it means that the game map correction area of the video frame is not corrected excessively, then an image of the game map correction area of the video frame is captured as the game map area image of this video frame.

In S270, the game map area image is input to a first target detection model to obtain a display area of a game element in the game map area image.

In S280, an image of the display area of the game element is input to a classification model to obtain a state of the game element.

In S290, description information of a game scene displayed by the at least one video frame is formed by adopting the display area and the state of the game element.

The S270, S280, and S290 are the same as S130, S140, and S150 in the foregoing embodiment, respectively, which will not to be detailed here again.

In this embodiment, the game map detection area is corrected by performing the feature matching on the route feature in the game map detection area and the reference feature, to obtain the game map correction area; if the deviation distance of the game map correction area relative to the game map detection area exceeds the deviation threshold, the image of the game map detection area in the video frame is captured; and if the deviation distance of the game map correction area relative to the game map detection area does not exceed the deviation threshold, the image of the game map correction area is captured, so that the game image is accurately positioned through the feature matching and area correction.

### Embodiment Three

This embodiment describes the S130 in the above embodiments. In this embodiment, the step in which the game map area image is input to the first target detection model to obtain the display area of the game element in the game map area image includes: the game map area image is input to the feature map generation sub-model to generate a feature map of the game map area image; the feature map is input to the grid segmentation sub-model to segment the feature map into multiple grids, where a difference between a size of each of the multiple grids and a minimum size of the game element is within a preset size range; the multiple grids are input to the positioning sub-model to obtain a matching degree between each of the multiple grids and features of multiple types of game elements; and an area corresponding to a grid with a maximum matching degree is determined as a display area of a corresponding type of game elements in the game map area image by adopting a non-maximum value suppression algorithm. FIG. 3 is a flowchart of a game scene description method provided in an embodiment three of the present application. As shown in FIG. 3, the method provided in this embodiment includes steps described below.

In S310, at least one video frame in a game live broadcast video stream is acquired.

The S310 is the same as the S110, which will not to be detailed here again.

In S320, a game map area image in the at least one video frame is captured.

For the description of the S320, please refer to the embodiment one and the embodiment two described above, which will not to be detailed here again.

In this embodiment, before the game map area image is input to the first target detection model to obtain the display area of the game element in the game map area image, the method further includes to train the first target detection model. In an embodiment, a training process of the first target detection model includes following two steps, that is, the first target detection module may be generated by training in a method including following two steps.

In a first step, multiple game map sample images are acquired, that is, images of a game map are acquired. The multiple game map sample images and the game map area image correspond to a same game type, and image features such as a color, a shape, a texture of the game element of the same type of games are the same. The first target detection model trained through the game map sample image may be applied to the recognition of the display area of the play element.

In a second step, the first target detection model is trained by using a training sample set constituted of the multiple game map sample images and the display area of the game element in the multiple game map sample images. In an embodiment, a difference between a display area output by the first target detection model and the display area in the sample set is used as a cost function, and iteration is repeated on parameters of the first target detection model until the cost function is below a loss threshold, and the training of the first target detection model is completed.

The first target detection model includes a feature map generation sub-model, a grid segmentation sub-model and a positioning sub-model which are connected in sequence. A detection process of the first target detection model is described below through S330 to S350.

In S330, the game map area image is input to the feature map generation sub-model to generate a feature map of the game map area image.

The feature map may be two-dimensional or three-dimensional.

In S340, the feature map is input to the grid segmentation sub-model to segment the feature map into multiple grids, where a difference between a size of each of the multiple grids and a minimum size of the game element is within a preset size range.

At least one game element is displayed in the game map. Sizes of different types of game elements are generally different. In order to avoid excessive segmentation of the grid, the difference between the size of each of the multiple grids and the minimum size of the game element is within the preset size range. In specific implementation, the size of the grid is expressed by adopting a hyper-parameter, and is set according to the minimum size of the game element before the first target detection model is trained.

In S350, the multiple grids are input to the positioning sub-model to obtain a matching degree between each of the multiple grids and features of multiple types of game elements.

In S360, an area corresponding to a grid with a maximum matching degree is determined as a display area of a corresponding type of game elements in the game map area image by adopting a non-maximum value suppression algorithm.

The positioning sub-model loads features of standard game elements, and each grid is essentially a grid-sized feature. The positioning sub-model matches each grid with features of the standard play elements by the positioning sub-model to obtain matching degrees of each grid with the features of the standard game elements, respectively. The matching degree is a cosine or a distance of these two features, for example.

Exemplarily, the game element includes two types of elements, i.e., game characters and defensive towers. The positioning sub-model loads features of standard game characters and features of standard defensive towers. The positioning sub-model matches a grid 1 with the feature of a standard game character to obtain a matching degree A; and the positioning sub-model matches the grid 1 with the feature of a standard defensive tower to obtain a matching degree B; then, the positioning sub-model matches a grid 2 with the feature of the standard game character to obtain a matching degree C., and the positioning sub-model matches the grid 2 with the feature of the standard defensive tower to obtain a matching degree D.

The non-maximum value suppression algorithm is used to search all the grids for a maximum value and suppress the non-maximum value to obtain that the matching degree C. is the maximum value, then an area corresponding to the grid 2 is taken as the display area of the game character. If the obtained matching degree C. and the obtained matching degree A are both maximum values, then an area where the grid 1 and the grid 2 are merged is taken as the display area of the game character.

In some embodiments, a certain game element is not displayed in the game map, and a matching degree threshold corresponding to the type of game element is set. The non-maximum value suppression algorithm is adopted for the matching degree exceeding the matching degree threshold. If all matching degrees do not exceed the matching degree threshold, it is considered that the game element is not displayed in the game map.

In S370, an image of the display area of the game element is input to a classification model to obtain a state of the game element.

The image of the display area of the game element is captured and then input to the classification model. The classification model pre-stores states and corresponding features of standard game elements. The classification model extracts a feature in the image and matches it with a pre-stored feature library corresponding to the states of the game elements to obtain a state corresponding to a feature with a highest matching degree.

In S380, description information of a game scene displayed by the at least one video frame is formed by adopting the display area and the state of the game element.

In this embodiment, accurate positioning of the game element is achieved through the feature map generation sub-model, the grid segmentation sub-model and the positioning sub-model, accurate classification of the game element is achieved through the classification model, and therefore the accuracy of game scene description is improved.

### Embodiment Four

FIG. 4 is a schematic structural diagram of a game scene description apparatus provided in an embodiment four of the present application. As shown in FIG. 4, the apparatus includes: an acquisition module 41, a capturing module 42, a display area recognition module 43, a state recognition module 44, and a forming module 45.

The acquisition module 41 is configured to acquire at least one video frame in a game live broadcast video stream. The capturing module 42 is configured to capture a game map area image in the at least one video frame. The display area recognition module 43 is configured to input the game map area image to a first target detection model to obtain a display area of a game element in the game map area image. The state recognition module 44 is configured to input an image of the display area of the game element to a classification model to obtain a state of the game element. The forming module 45 is configured to form description information of a game scene displayed by the at least one video frame by adopting the display area and the state of the game element.

In this embodiment, a game map, which is capable of reflecting a game situation, is acquired from the game live broadcast video stream by acquiring the at least one video frame in the game live broadcast video stream and capturing the game map area image in the at least one video frame; the display area and the state of the game element in the game map area image are obtained through the first target detection model and the classification model, the display area and the state of the game element are extracted by applying an image recognition algorithm based on a deep learning for the understanding of the game map; and then, the description information of the game scene displayed by the at least one video frame is formed by adopting the display area and the state of the game element, so that a specific game scene inside the game live broadcast video stream is obtained by taking the game map as a recognization object and in conjunction with the image recognization algorithm, which facilitates the subsequent push or classification of the game live broadcast video stream in the specific game scene, satisfies the personalized requirements of users, and is conductive to improve the content distribution efficiency of the game live broadcast industry.

In an implementation manner, the capturing module 42 is configured to: input at least one video frame to a second target detection model to obtain a game map detection area each of the at least one video frame; correct the game map detection area by performing feature matching on a route feature in the game map detection area and a reference feature, to obtain a game map correction area; in a case where a deviation distance of a game map correction area of one video frame of the at least one video frame relative to a game map detection area of the one video frame exceeds a deviation threshold, capture an image of the game map detection area in the one video frame; and in a case where a deviation distance of a game map correction area of one video frame of the at least one video frame relative to a game map detection area of the one video frame does not exceed the deviation threshold, capture an image of the game map correction area in the one video frame.

In an implementation manner, the apparatus further includes a training module. Before the at least one video frame is input to the second target detection model, the training module is configured to: acquire multiple sample video frames, the multiple sample video frames and the at least one video frame corresponding to a same game type; and constitute a training sample set by the multiple sample video frames and a display area of a game map in the multiple sample video frames, and train the second target detection model.

In an implementation manner, before the game map area image is input to the first target detection model to obtain the display area of the game element in the game map area image, the training module is further configured to: acquire multiple game map sample images, the multiple game map sample images and the game map area image corresponding to a same game type; and constitute a training sample set by the multiple game map sample images and a display area of a game element in the multiple game map sample images, and train the first target detection model.

In an implementation manner, the first target detection model includes a feature map generation sub-model, a grid segmentation sub-model, and a positioning sub-model. The display area recognition module 43 is configured to: input the game map area image to the feature map generation sub-model to generate a feature map of the game map area image; input the feature map to the grid segmentation sub-model to segment the feature map into multiple grids, a difference between a size of each of the multiple grids and a minimum size of the game element being within a preset size range; input the multiple grids to the positioning sub-model to obtain a matching degree between each of the multiple grids and features of multiple types of game elements; and determine an area corresponding to a grid with a maximum matching degree as a display area of a corresponding type of game elements in the game map area image by adopting a non-maximum value suppression algorithm.

In an implementation manner, the forming module 45 is configured to: obtain description information of a game scene displayed by one video frame of the at least one video frame according to a correspondence between the description information and a display area and a state of the game element in the video frame; or, obtain change trends of the display area and the state of the game element in two or more video frames; and obtain description information of a game scene displayed by the two or more video frames according to a correspondence between the change trends and the description information.

The game scene description apparatus provided by the embodiments of the present application may execute the game scene description method provided by any of the embodiments of the present application, and has function modules and beneficial effects corresponding to the execution method.

### Embodiment Five

FIG. 5 is a structural diagram of an electronic device provided in an embodiment five of the present application. The electronic device may be a server, an anchor client, or a user client. As shown in FIG. 5, the electronic device includes a processor 50 and a memory 51; the number of processors 50 in the electronic device may be one or more, and one processor 50 is taken as an example in FIG. 5; the processor 50 and the memory 51 in the electronic device may be connected through a bus or in other ways, such as by way of a bus connection in FIG. 5.

The memory 51 serves as a computer-readable storage medium and may be used for storing software programs, computer executable programs, and modules, such as program instructions/modules corresponding to the game scene description method in the embodiments of the present application (such as, the acquisition module 41, the capturing module 42, the display area recognition module 43, the state recognition module 44 and the forming module 45 in the game scene description apparatus). The processor 50 executes various functional applications and data processing of the electronic device by running the software programs, the instructions, and the modules stored in the memory 51, that is, the above-described game scene description method is achieved.

The memory 51 may mainly include a program storage area and a data storage area. The program storage area may store an operating system and application programs required by at least one function; the storage data area may store data created according to the use of the terminal, etc. In addition, the memory 51 may include a high-speed random access memory, and may also include a non-volatile memory, such as at least one magnetic disk storage device, a flash memory device, or other non-volatile solid-state storage devices. In some examples, the memory 51 may include memories remotely provided with respect to the processor 50, and these remote memories may be connected to electronic devices through a network. Examples of the above network include, but are not limited to, Internet, enterprise intranet, local area network, mobile communication network, and combinations thereof.

### Embodiment Six

The embodiment six of the present application further provides a computer-readable storage medium on which a computer program is stored. The computer program, when executed by a computer processor, is used for performing a game scene description method. The method includes: at least one video frame in a game live broadcast video stream is acquired; a game map area image in the at least one video frame is captured; the game map area image is input to a first target detection model to obtain a display area of a game element in the game map area image; an image of the display area of the game element is input to a classification model to obtain a state of the game element; and description information of a game scene displayed by the at least one video frame is formed by adopting the display area and the state of the game element.

Of course, in the computer-readable storage medium having the computer program stored thereon provided by the embodiments of the present application, the computer program of the computer-readable storage medium is not limited to the method operations described above, but may also perform related operations in the game scenario description method provided by any of the embodiments of the present application.

Those skilled in the art will appreciate from the above description of the implementation manners that the present application may be implemented by software and general purpose hardware, and of course may also be implemented by hardware. Based on this understanding, the technical scheme of the present application may be embodied in the form of a software product, and the computer software product may be stored in a computer readable storage medium, such as a floppy disk of a computer, a read-only memory (ROM), a random access memory (RAM), a flash memory (FLASH), a hard disk or an optional disk, including multiple instructions to enable a computer device (which may be a personal computer, a server, or a network device, etc.) to perform the method of any of the embodiments of the present application.

It is worth noting that in the above embodiments of the game scene description apparatus, the multiple units and modules included in the game scene description apparatus are only divided according to the function logic and are not limited to the above division, as long as the corresponding functions may be achieved; in addition, the name of each functional unit is also merely to facilitate distinguishing from each other and is not intended to limit the scope of protection of the present application.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A game scene description method, comprising:
acquiring at least one video frame in a game live broadcast video stream;
capturing a game map area image in the at least one video frame;
inputting the game map area image to a first target detection model to obtain a display area of a game element in the game map area image;
inputting an image of the display area of the game element to a classification model to obtain a state of the game element; and
forming description information of a game scene displayed by the at least one video frame by adopting the display area and the state of the game element.

2. The method of claim 1, wherein capturing the game map area image in the at least one video frame comprises:
inputting the at least one video frame to a second target detection model to obtain a game map detection area in the at least one video frame;
correcting the game map detection area by performing feature matching on a route feature in the game map detection area and a reference feature, to obtain a game map correction area; and
in a case where a deviation distance of a game map correction area of one video frame of the at least one video frame relative to a game map detection area of the one video frame exceeds a deviation threshold, capturing an image of the game map detection area in the one video frame.

3. The method of claim 2, further comprising:
in a case where the deviation distance of the game map correction area of the one video frame relative to the game map detection area of the one video frame does not exceed the deviation threshold, capturing an image of the game map correction area in the one video frame.

4. The method of claim 2, wherein before inputting the at least one video frame to the second target detection model, the method further comprises:
acquiring a plurality of sample video frames, wherein the plurality of sample video frames and the at least one video frame correspond to a same game type; and
constituting a second training sample set by the plurality of sample video frames and a display area of a game map in the plurality of sample video frames, and training the second target detection model by using the second training sample set.

5. The method of claim 1, before inputting the game map area image to the first target detection model to obtain the display area of the game element in the game map area image, the method further comprises:
acquiring a plurality of game map sample images, wherein the plurality of game map sample images and the game map area image correspond to a same game type; and
constituting a first training sample set by the plurality of game map sample images and a display area of a game element in the plurality of game map sample images, and training the first target detection model by using the first training sample set.

6. The method of claim 1, wherein the first target detection model comprises a feature map generation sub-model, a grid segmentation sub-model, and a positioning sub-model;
wherein inputting the game map area image to the first target detection model to obtain the display area of the game element in the game map area image comprises:
inputting the game map area image to the feature map generation sub-model to generate a feature map of the game map area image;
inputting the feature map to the grid segmentation sub-model to segment the feature map into a plurality of grids, wherein a difference between a size of each of the plurality of grids and a minimum size of the game element is within a preset size range;
inputting the plurality of grids to the positioning sub-model to obtain a matching degree between each of the plurality of grids and a feature of a respective one of a plurality of types of game elements; and
determining an area corresponding to a grid with a maximum matching degree as a display area of a corresponding type of game elements in the game map area image by adopting a non-maximum value suppression algorithm.

7. The method of claim 1, wherein forming the description information of the game scene displayed by the at least one video frame by adopting the display area and the state of the game element comprises:
obtaining description information of a game scene displayed by one video frame of the at least one video frame according to a correspondence between the description information and a display area and a state of the game element in the one video frame;
or,
wherein forming the description information of the game scene displayed by the at least one video frame by adopting the display area and the state of the game element comprises:
obtaining a display area change trend from a display area of the game element in a plurality of video frames, and obtaining a state change trend from a state of the game element in the plurality of video frames; and
obtaining description information of a game scene displayed by the plurality of video frames according to a correspondence between the description information and the display area change trend and the state change trend of the game element.

8. A game scene description apparatus, comprising:
an acquisition module, which is configured to acquire at least one video frame in a game live broadcast video stream;
a capturing module, which is configured to capture a game map area image in the at least one video frame;
a display area recognition module, which is configured to input the game map area image to a first target detection model to obtain a display area of a game element in the game map area image;
a state recognition module, which is configured to input an image of the display area of the game element to a classification model to obtain a state of the game element; and
a forming module, which is configured to form description information of a game scene displayed by the at least one video frame by adopting the display area and the state of the game element.

9. An electronic device, comprising:
at least one processor; and
a memory, which is configured to store at least one program;
wherein the at least one program, when executed by the at least one processor, causes the at least one processor to implement a game scene description method,
wherein the game scene description method comprises:
acquiring at least one video frame in a game live broadcast video stream:
capturing a game map area image in the at least one video frame;
inputting the game map area image to a first target detection model to obtain a display area of a game element in the game map area image:
inputting an image of the display area of the game element to a classification model to obtain a state of the game element; and
forming description information of a game scene displayed by the at least one video frame by adopting the display area and the state of the game element.

10. A computer-readable storage medium, storing a computer program, wherein the computer program, when executed by a processor, implements the game scene description method of claim 1.

11. The electronic device of claim 9, wherein capturing the game map area image in the at least one video frame comprises:
inputting the at least one video frame to a second target detection model to obtain a game map detection area in the at least one video frame;
correcting the game map detection area by performing feature matching on a route feature in the game map detection area and a reference feature, to obtain a game map correction area; and
in a case where a deviation distance of a game map correction area of one video frame of the at least one video frame relative to a game map detection area of the one video frame exceeds a deviation threshold, capturing an image of the game map detection area in the one video frame.

12. The electronic device of claim 11, further comprising:
in a case where the deviation distance of the game map correction area of the one video frame relative to the game map detection area of the one video frame does not exceed the deviation threshold, capturing an image of the game map correction area in the one video frame.

13. The electronic device of claim 11, wherein before inputting the at least one video frame to the second target detection model, the method further comprises:
acquiring a plurality of sample video frames, wherein the plurality of sample video frames and the at least one video frame correspond to a same game type; and
constituting a second training sample set by the plurality of sample video frames and a display area of a game map in the plurality of sample video frames, and training the second target detection model by using the second training sample set.

14. The electronic device of claim 9, before inputting the game map area image to the first target detection model to obtain the display area of the game element in the game map area image, the method further comprises:
acquiring a plurality of game map sample images, wherein the plurality of game map sample images and the game map area image correspond to a same game type; and
constituting a first training sample set by the plurality of game map sample images and a display area of a game element in the plurality of game map sample images, and training the first target detection model by using the first traning sample set.

15. The electronic device of claim 9, wherein the first target detection model comprises a feature map generation sub-model, a grid segmentation sub-model, and a positioning sub-model;
wherein inputting the game map area image to the first target detection model to obtain the display area of the game element in the game map area image comprises:
inputting the game map area image to the feature map generation sub-model to generate a feature map of the game map area image;
inputting the feature map to the grid segmentation sub-model to segment the feature map into a plurality of grids, wherein a difference between a size of each of the plurality of grids and a minimum size of the game element is within a preset size range;
inputting the plurality of grids to the positioning sub-model to obtain a matching degree between each of the plurality of grids and a feature of a respective one of a plurality of types of game elements; and
determining an area corresponding to a grid with a maximum matching degree as a display area of a corresponding type of game elements in the game map area image by adopting a non-maximum value suppression algorithm.

16. The electronic device of claim 9, wherein forming the description information of the game scene displayed by the at least one video frame by adopting the display area and the state of the game element comprises:
obtaining description information of a game scene displayed by one video frame of the at least one video frame according to a correspondence between the description information and a display area and a state of the game element in the one video frame;
or,
wherein forming the description information of the game scene displayed by the at least one video frame by adopting the display area and the state of the game element comprises:
obtaining a display area change trend from a display area of the game element in a plurality of video frames, and obtaining a state change trend from a state of the game element in the plurality of video frames; and
obtaining description information of a game scene displayed by the plurality of video frames according to a correspondence between the description information and the display area change trend and the state change trend of the game element.
